(19) United States
(12) Patent Application Publication
(10) Pub. No.: US 2019/0024946 A1
(43) Pub. Date: Jan. 24, 2019

(54) PHOTOVOLTAIC MODULE FLOATING SUPPORTING STRUCTURE

(71) Applicant: SUNGROW POWER SUPPLY CO., LTD., Hefei Anhui (CN)

(72) Inventors: Yukun WANG, Hefei Anhui (CN); Fuqin XIAO, Hefei Anhui (CN); Yimin XU, Hefei Anhui (CN); Hao WU, Hefei Anhui (CN); Duo LI, Hefei Anhui (CN); Jinpeng SONG, Hefei Anhui (CN)

(21) Appl. No.: 15/911,878

(22) Filed: Mar. 5, 2018

(30) Foreign Application Priority Data
Jul. 18, 2017 (CN) 201720873651.0
Sep. 29, 2017 (CN) 201721275446.0

(51) Int. Cl. F24S 20/70; H02S 20/30; B63B 35/44

(52) U.S. Cl. CPC F24S 20/70; B63B 2035/4453; H02S 20/30

(57) ABSTRACT

A photovoltaic module floating supporting structure according to the present application includes a floating body and a first supporting plate integrally formed with the floating body and configured to be connected to a connecting assembly, the first supporting plate has an upper surface smoothly connected to an upper surface of the floating body, and has a lower surface smoothly connected to a lower surface of the floating body. In use, the connecting assembly is installed on the first supporting plate and the photovoltaic module is installed on the connecting assembly.

### CROSS REFERENCE TO RELATED APPLICATION

The present application claims priority under 35 U.S.C. § 119 to Chinese Application No. 201720873651.0 filed July 18, 2017 and Chinese Application No. 201721275446.0, filed Sep. 29, 2017, the entire content of which is incorporated herein by reference in its entirety.

### FIELD

This application relates to the technical field of waterborne photovoltaic devices, and in particular to a photovoltaic module floating supporting structure.

### BACKGROUND

In order to save land resources and make full use of the high reflectivity and low temperature properties of water surface to enhance the power generation rate, waterborne floating power stations are set up. The waterborne floating power station includes a photovoltaic module floating supporting structure and a photovoltaic module connected to the photovoltaic module floating supporting structure by a connecting assembly.

A conventional photovoltaic module floating supporting structure includes a floating body and a T-shaped connecting column base arranged on an upper surface of the floating body. An upright column of the connecting assembly is clamped at the T-shaped connecting column base to be fixed to the floating body. The T-shaped connecting column base has one end integrated with the floating body and another end engaged with the upright column. When manufacturing the photovoltaic module floating supporting structure, it first needs to make a T-shaped connecting slot by injection molding, and then pre-embed the T-shaped connecting slot into the floating body by blow molding, to allow the T-shaped connecting slot be integrally formed with the floating body.

However, since the T-shaped connecting column base of the floating body is a weak point for load bearing, and stress is concentrated at a root of the T-shaped connecting slot for a long term. With the aging and deterioration of the resin material, the stress concentration is becoming more and more serious. The root of the T-shaped connecting slot is apt to be broken, resulting in a short service life of the photovoltaic module floating supporting structure.

Therefore, a technical issue to be addressed urgently by the person skilled in the art is to prolong the service life of a photovoltaic module floating supporting structure.

### SUMMARY

An object of the present application is to provide a photovoltaic module floating supporting structure which has a prolonged service life.

In order to achieve the above object, a photovoltaic module floating supporting structure is provided according to the present application, which includes a floating body, and further includes a first supporting plate integrally formed with the floating body and configured to be connected to a connecting assembly. The first supporting plate has an upper surface smoothly connected to an upper surface of the floating body and a lower surface smoothly connected to a lower surface of the floating body.

Preferably, the photovoltaic module floating supporting structure further includes a second supporting plate integrally formed with the floating body and configured to be connected to the connecting assembly. An inner support groove is defined by the second supporting plate and the upper surface of the floating body.

Preferably, the first supporting plate and/or the second supporting plate are solid structures.

Preferably, the upper surface of the first supporting plate is provided with a first connection positioning hole and a first drainage groove in communication with the first connection positioning hole;
and/or, an upper surface of the second supporting plate is provided with a second connection positioning hole and a second drainage groove in communication with the second connection positioning hole.

Preferably, the first supporting plate is arranged on a lateral side of the floating body, multiple first supporting plates are provided, and the multiple first supporting plates are symmetrically distributed at opposite sides of the floating body along a center line of the floating body.

Preferably, the upper surface of the floating body is provided with an inclined support groove configured to connect the first supporting plate to the second supporting plate.

Preferably, the floating body is provided with a cooling hole, and two ends of the cooling hole are respectively in communication with the upper surface of the floating body and the lower surface of the floating body.

Preferably, a side surface, for forming the cooling hole, of the floating body is provided with an inner sidewall reinforcing rib, multiple inner sidewall reinforcing ribs are provided, and the multiple inner sidewall reinforcing ribs are distributed at equal intervals in a peripheral direction of the cooling hole.

Preferably, the upper surface of the floating body is provided with a transverse reinforcing rib and a longitudinal reinforcing rib arranged perpendicularly to the transverse reinforcing rib, the transverse reinforcing rib is connected to the longitudinal reinforcing rib, a lateral side of the floating body is provided with an outer sidewall reinforcing rib, and the lower surface of the floating body is provided with a bottom reinforcing rib.

Preferably, each of the transverse reinforcing rib, the longitudinal reinforcing rib and the bottom reinforcing rib is recessed inward from the respective surface of the floating body.

Preferably, the upper surface of the floating body includes an arc-shaped reinforcing surface recessed toward the center of the upper surface of the floating body and a flat surface surrounding a periphery of the arc-shaped reinforcing surface, and the flat surface is smoothly connected to a side portion of the arc-shaped reinforcing surface.

Preferably, the photovoltaic module floating supporting structure further includes a connecting lug. The first supporting plate and the connecting lug are integrally formed, and a mounting surface of the connecting lug is coplanar with a mounting surface of the first supporting plate.

Preferably, the upper surface of the floating body is provided with a first drainage passage concaved inward from two ends of the floating body toward a center of the floating body and two second drainage passages respectively arranged at two opposite sides of a bottommost portion of the first drainage passage, and each of the second drainage passages has one end in communication with the first drainage passage and another end extending to an outer periphery of the floating body to form a drainage opening.

Preferably, the lower surface of the floating body is provided with a reinforcement supporting member, the reinforcement supporting member is integrally formed with the floating body, and the reinforcement supporting member has two ends respectively connected to the upper surface and the lower surface of the floating body.

Preferably, the reinforcement supporting member is located at a center of the floating body, the lower surface of the floating body is provided with a bottom supporting strip surrounding the reinforcement supporting member, and the bottom supporting strip is integrally formed with the floating body.

In the above technical solutions, the photovoltaic module floating supporting structure according to the present application includes a floating body and a first supporting plate integrally formed with the floating body and configured to be connected to a connecting assembly, The first supporting plate has an upper surface smoothly connected to an upper surface of the floating body, and has a lower surface smoothly connected to a lower surface of the floating body. In use, the connecting assembly is installed on the first supporting plate and the photovoltaic module is installed on the connecting assembly.

According to the above description, in the photovoltaic module floating supporting structure according to the present application, the first supporting plate is integrally formed with the floating body, and the connecting assembly is connected to the first supporting plate, thus stress concentration is avoided, the strength of connection between the photovoltaic module floating supporting structure and the connecting assembly is improved, the safety of the power generation of the photovoltaic module is ensured, and the service life of the photovoltaic module floating supporting structure is effectively prolonged.

### BRIEF DESCRIPTION OF THE DRAWINGS

For more clearly illustrating embodiments of the present application or the technical solutions in the conventional technology, drawings referred to describe the embodiments or the conventional technology will be briefly described hereinafter. Apparently, the drawings in the following description are only examples of the present application, and for the person skilled in the art, other drawings may be obtained based on the drawings provided without any creative efforts.

FIG. 1 is a schematic view showing the structure of a first type of photovoltaic module floating supporting structure according to an embodiment of the present application;

FIG. 2 is a schematic view showing the connection structure between the photovoltaic module floating supporting structure in FIG. 1 and a connecting assembly;

FIG. 3 is a partially enlarged view showing the connection structure between the photovoltaic module floating supporting structure and the connecting assembly in FIG. 2;

FIG. 4 is a schematic view showing a mounting position of the photovoltaic module floating supporting structure in FIG. 1 and a photovoltaic module;

FIG. 5 is a schematic view showing the mounting position of the photovoltaic module floating supporting structure in FIG. 1;

FIG. 6 is a schematic view showing the structure of a second type of photovoltaic module floating supporting structure according to an embodiment of the present application;

FIG. 7 is a schematic view showing the structure of a third type of photovoltaic module floating supporting structure according to an embodiment of the present application;

FIG. 8 is a side view of the photovoltaic module floating supporting structure in FIG. 7;

FIG. 9 is a schematic view showing the structure of a fourth type of photovoltaic module floating supporting structure according to an embodiment of the present application;

FIG. 10 is a side view of the photovoltaic module floating supporting structure in FIG. 9;

FIG. 11 is a partially enlarged view of a first supporting plate of the photovoltaic module floating supporting structure in FIG. 9;

FIG. 12 is a sectional view of the first supporting plate in FIG. 11;

FIG. 13 is a schematic view showing the mounting position of the photovoltaic module floating supporting structure in FIG. 9.

FIG. 14 is a partially enlarged view of a connecting lug of the photovoltaic module floating supporting structure in FIG. 9;

FIG. 15 is a bottom view of the photovoltaic module floating supporting structure in FIG. 9;

FIG. 16 is a schematic view showing the connection structure between the photovoltaic module floating supporting structure in FIG. 9 and a connecting assembly;

FIG. 17 is an enlarged view of the position of the connecting assembly in FIG. 16.

FIG. 18 is a partially enlarged view of the connecting assembly in FIG. 17;

FIG. 19 is a schematic view showing the mounting position of the photovoltaic module floating supporting structure in FIG. 9 and the photovoltaic module;

FIG. 20 is a schematic view showing the structure of a fifth type of photovoltaic module floating supporting structure according to an embodiment of the present application;

FIG. 21 is a schematic view showing the mounting position of the photovoltaic module floating supporting structure in FIG. 20 and the photovoltaic module;

FIG. 22 is a schematic view showing the structure of a sixth type of photovoltaic module floating supporting structure according to an embodiment of the present application;

FIG. 23 is a side view of the photovoltaic module floating supporting structure in FIG. 22;

FIG. 24 is a partially enlarged view of the photovoltaic module floating supporting structure in FIG. 22;

FIG. 25 is a schematic view showing the mounting position of the photovoltaic module floating supporting structure in FIG. 22 and the connecting assembly;

FIG. 26 is a schematic view showing the mounting position of the photovoltaic module floating supporting structure in FIG. 22 and the photovoltaic module;

FIG. 27 is a schematic view showing the structure of a seventh type of photovoltaic module floating supporting structure according to an embodiment of the present application;

FIG. 28 is a bottom view of the photovoltaic module floating supporting structure in FIG. 27; and

FIG. 29 is a schematic view showing the mounting position of the photovoltaic module floating supporting structure in FIG. 27 and the photovoltaic module.

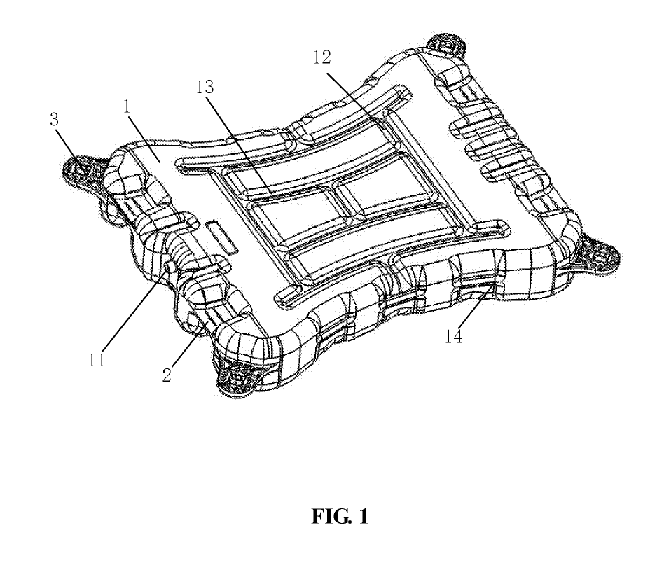

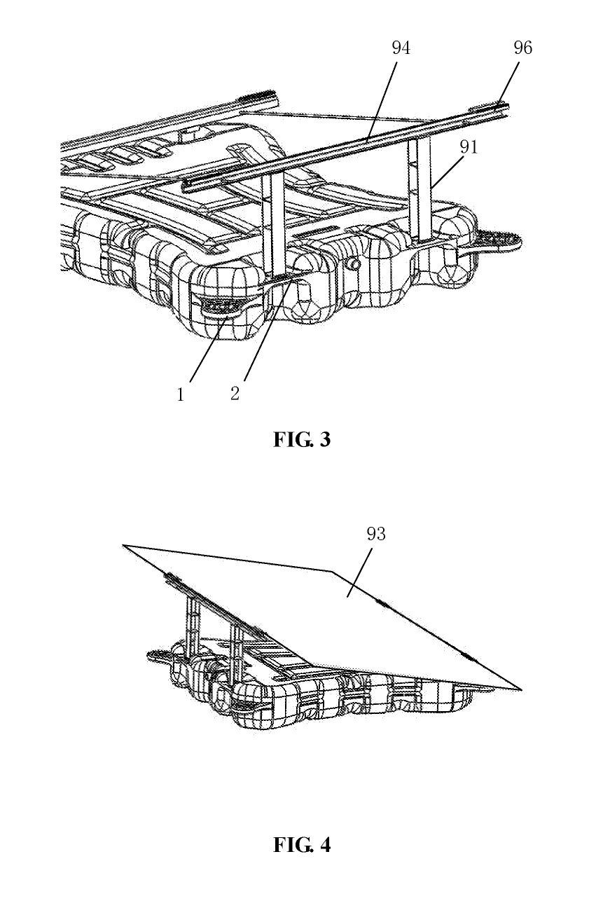

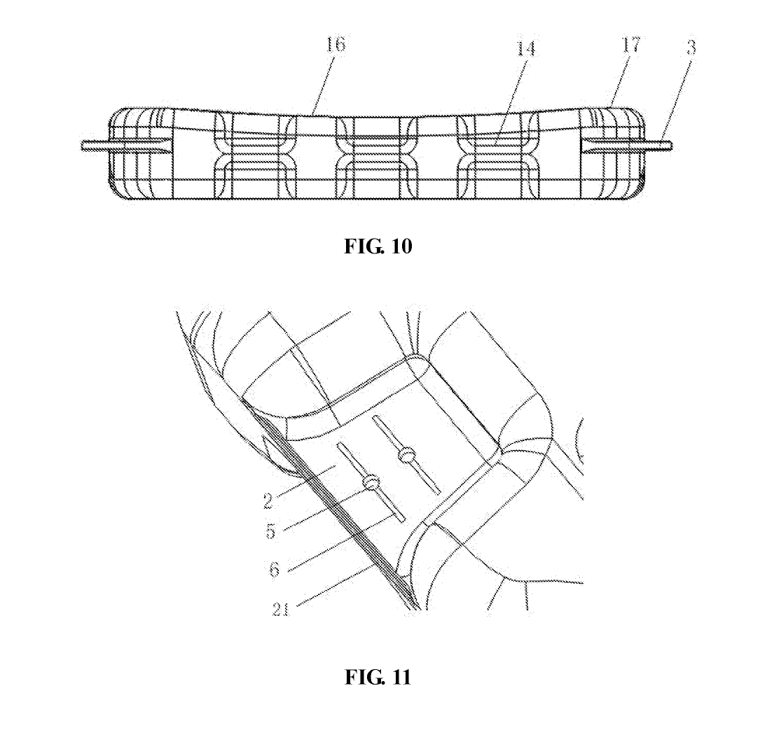

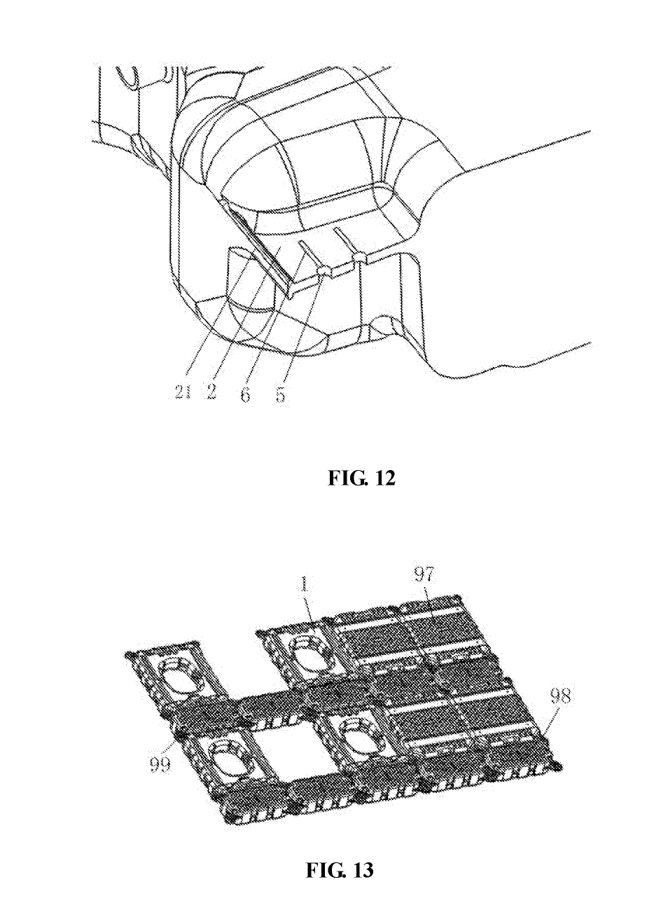

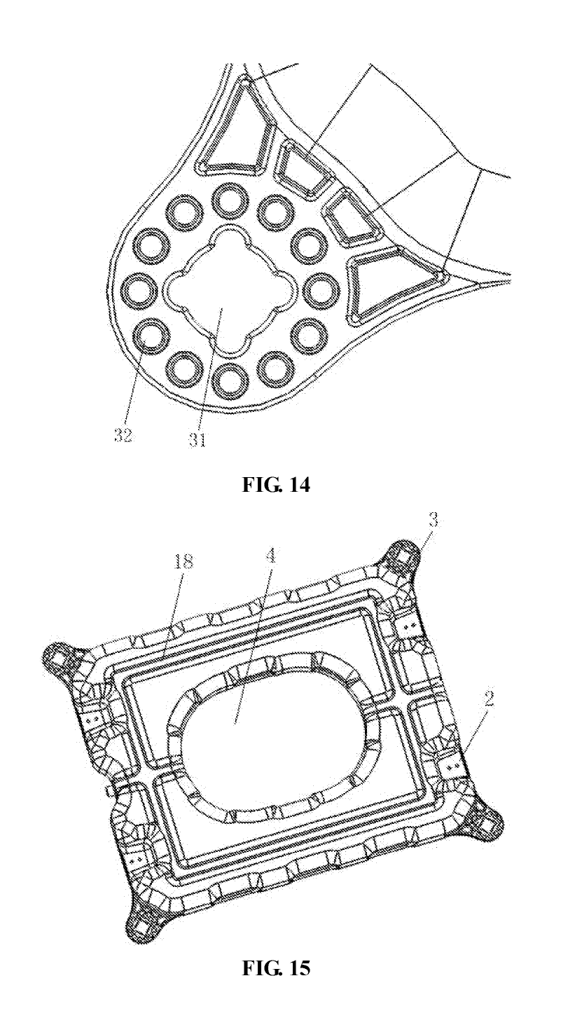

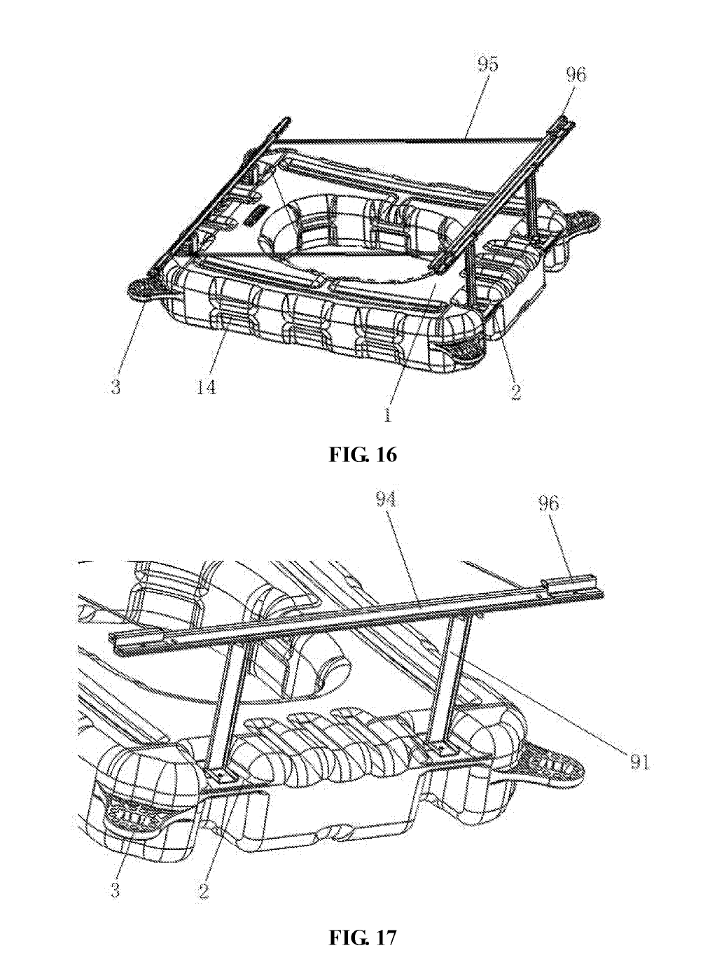

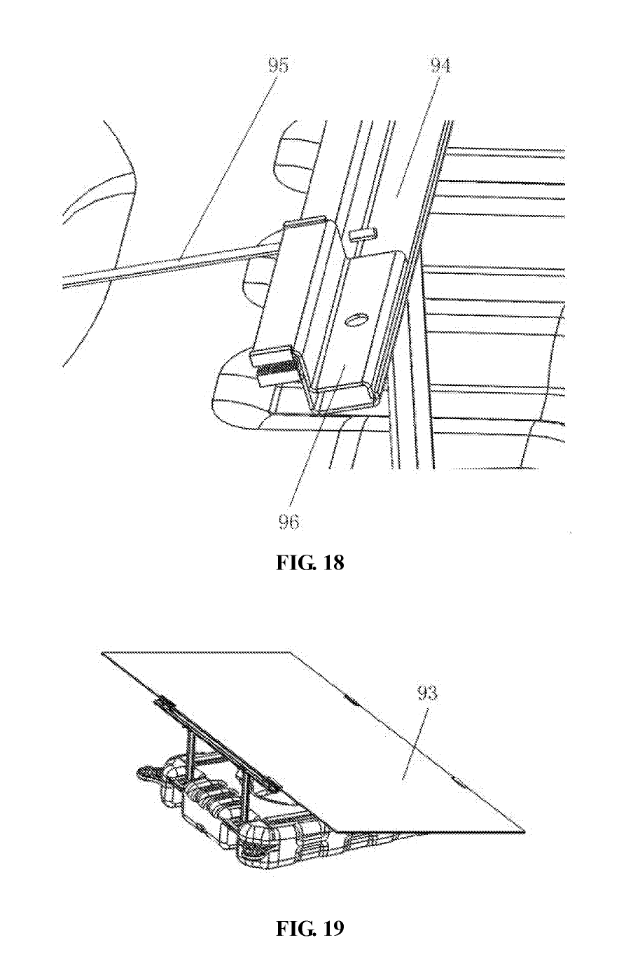

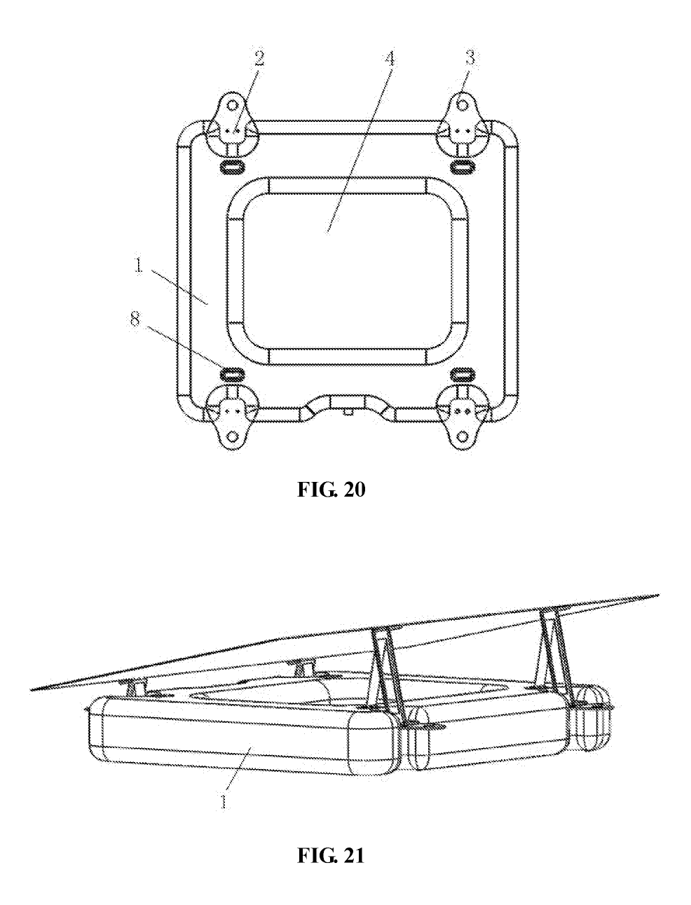

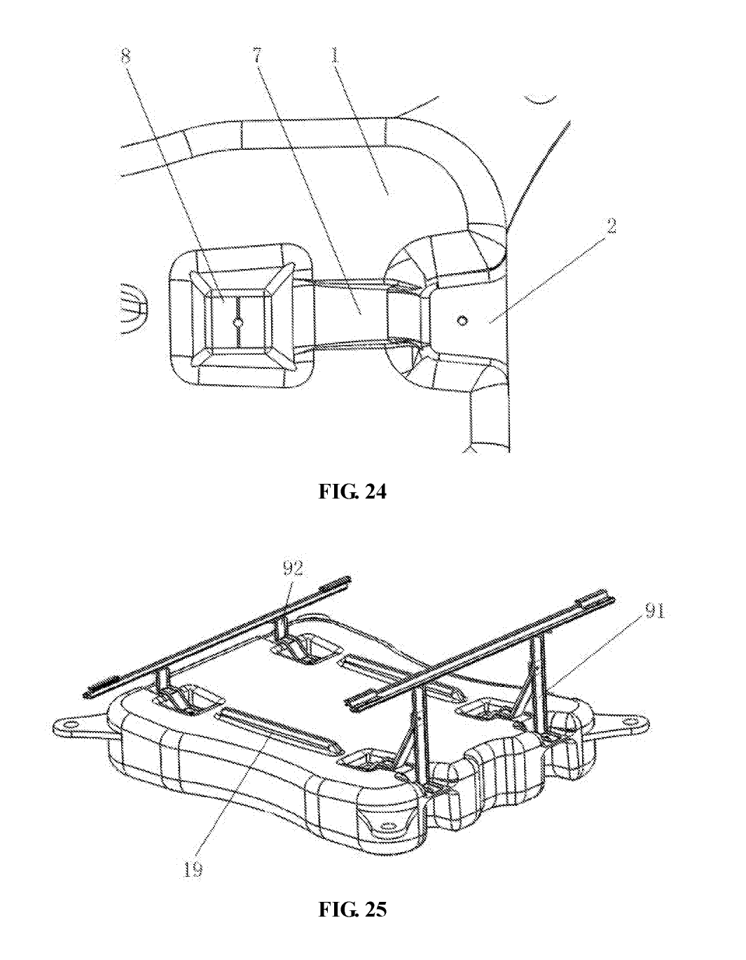

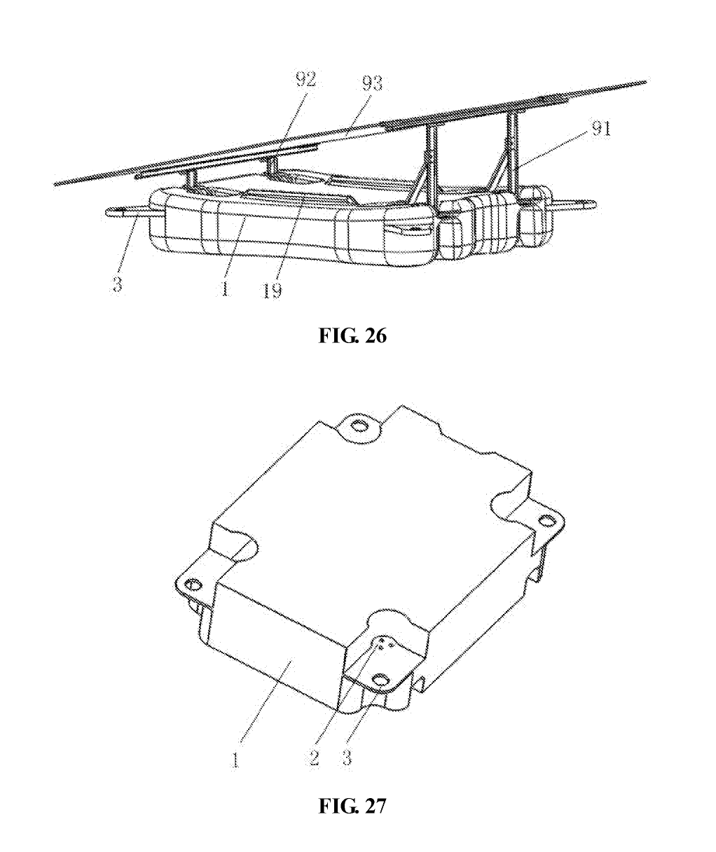

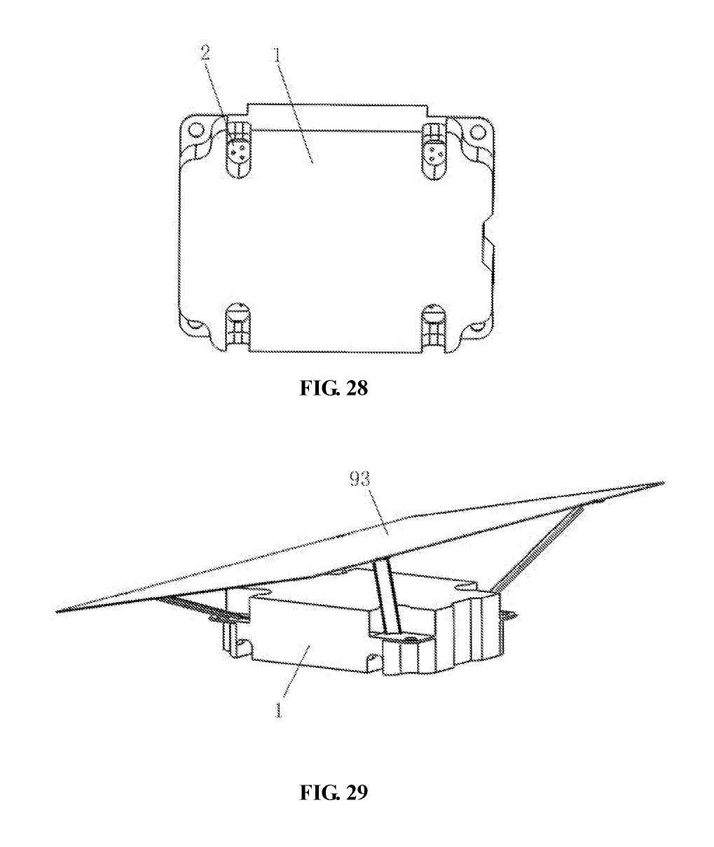

### REFERENCE NUMERALS IN FIG. 1 TO FIG. 29

1 floating body,

11 air blowing port,

12 transverse reinforcing rib,

13 longitudinal reinforcing rib,

14 outer sidewall reinforcing rib,

15 inner sidewall reinforcing rib,

16 arc-shaped reinforcing surface,

17 flat surface,

18 bottom reinforcing rib,

19 upper reinforcing rib;

110 first drainage passage;

111 second drainage passage;

112 reinforcement supporting member;

113 bottom supporting strip;

2 first supporting plate,

21 cantilevered reinforcing rib,

3 connecting lug,

31 connecting lug positioning hole,

32 anti-reverse rotating hole,

4 cooling hole,

5 first connection positioning hole,

6 first drainage groove,

7 inclined support groove,

8 second supporting plate;

91 rear support leg,

92 front support leg,

93 photovoltaic module,

94 transverse guide rail,

95 tie rod,

96 pressing block,

97 floating bodies for convergence boxes and string inverters,

98 bolt-nut connecting pair,

99 floating walkway.

### DETAILED DESCRIPTION

A photovoltaic module floating supporting structure is provided according to the present application, which has an prolonged service life.

For enabling the person skilled in the art to better understand the technical solution of the present application, the present application will be described in detail further with reference to the drawings and embodiments.

Referring to FIG. 1 to FIG. 29, in an embodiment, a photovoltaic module floating supporting structure according to the embodiment of the present application includes a floating body 1, and a first supporting plate 2 formed integrally with the floating body 1 and configured to be connected to a connecting assembly. The floating body 1 is provided with an air blowing port 11. Preferably, the air blowing port 11 is located in a lateral side of the floating body 1. For making it easy for the worker to assemble the waterborne floating power station, it is preferable that the first supporting plate 2 and the connecting assembly are connected by a bolt mounted in a first connection positioning hole 5. For facilitating the formation of the first supporting plate 2 and the improvement of its connection strength, preferably, the first supporting plate 2 is a solid structure, and an upper surface of the first supporting plate 2 is smoothly connected to an upper surface of the floating body 1, and a lower surface of the first supporting plate 2 is smoothly connected to a lower surface of the floating body 1. For prolonging the service life of the photovoltaic module floating supporting structure, preferably, the upper surfaces of the first supporting plate 2 and the floating body 1 are in arc transition, and the lower surfaces of the first supporting plate 2 and the floating body 1 are also in arc transition. For facilitating the formation of the first supporting plate 1, it is preferable that the first supporting plate 2 is arranged on the lateral side of the floating body 1, and it is preferable that the lateral side of the floating body 1 is provided with a U-shaped groove for accommodating the first supporting plate 2, and three lateral sides of the first supporting plate 2 are connected to the floating body. Thus, the stress concentration is further avoided by increasing the area of the junction between the first supporting plate 2 and the floating body 1, and the service life of the photovoltaic module floating supporting structure is effectively prolonged.

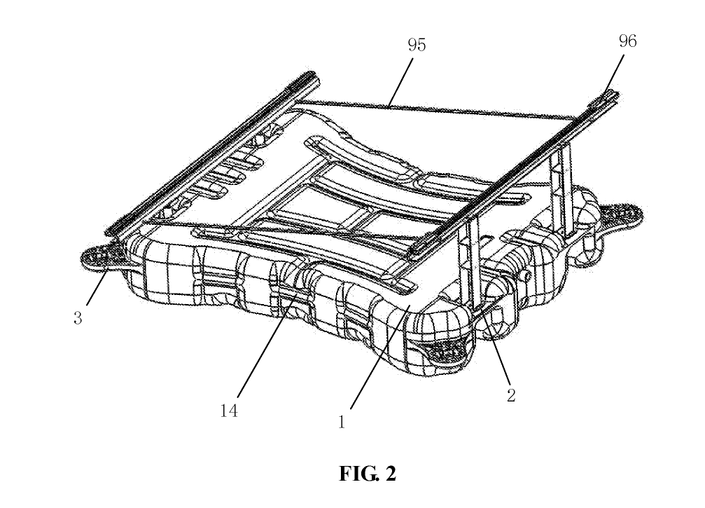

A connecting lug 3 may be arranged independently with respect to the first supporting plate 2. The connecting lugs 3 are provided at corners of two ends of the floating body 1. The first supporting plate 2 is arranged on the lateral side of the floating body 1, and there are multiple first supporting plates 2, and the multiple first supporting plates 2 are symmetrically distributed on opposite lateral sides of the floating body 1 along the center line of the floating body 1. Generally, the floating body 1 is a rectangular solid overall, and preferably, four connecting lugs 3 are arranged on the floating body 1, and the first supporting plates 2 are provided on the lateral sides of the floating body 1, and the specific number and position of the first supporting plates 2 are set according to practical installation requirements. As shown in FIG. 2, four of the first supporting plate 2 may be provided, and the four first supporting plates 2 are distributed on opposite sides of the floating body 1 with two first supporting plates 2 on each side.

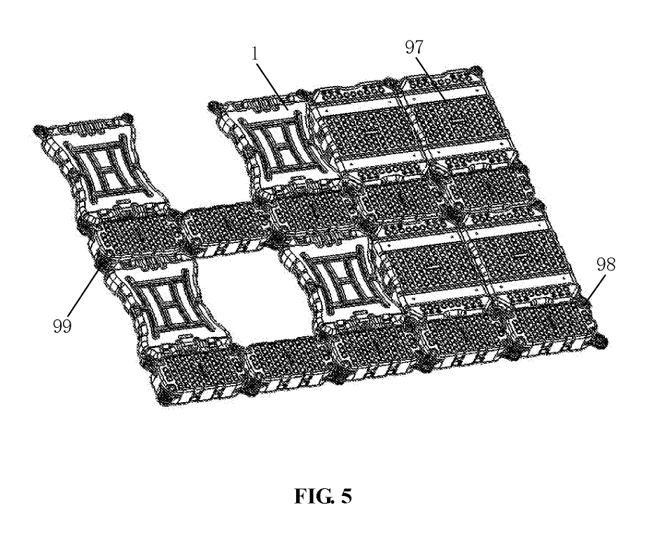

As shown in FIG. 4 and FIG. 5, to make it easy for the worker to install the connecting assembly, it is preferable that the first supporting plate 2 is provided with a first connection positioning hole 5 and the first supporting plate 2 may be provided with several first connection positioning holes 5. For prolonging the service life of the photovoltaic module floating supporting structure, it is preferable that, in the case that the first supporting plate 2 is arranged on an outer side surface of the floating body 1, a cantilevered reinforcing rib 21 is provided on a side, away from the floating body 1, of the first supporting plate 2. For preventing water remaining on the upper surface of the first supporting plate 2, it is preferable that the upper surface of the first supporting plate 2 is provided with a drainage groove 6 in communication with the first connection positioning hole 5, and the number of the drainage groove 6 is determined according to the practical requirements. By providing the drainage groove 6, the accumulated water on the first supporting plate 2 is discharged slowly via a gap between the first connection positioning hole 5 and the drainage groove 6. The cantilevered reinforcing rib 21 can enhance the deformation resistance of the first supporting plate 2, to withstand creep deformation caused by a long-term stress.

In use, the connecting assembly is installed on the first supporting plate 2, and a photovoltaic module 93 is installed on the connecting assembly. Support legs are fixed to the first supporting plates 2, and the first supporting plates 2 at opposite sides of the floating body 1 are reliably connected to front support legs 92 and rear support legs 91, respectively, by means of bolt sets via the first connection positioning holes 5. There is a certain height difference between the front support legs 92 and the rear support legs 91, thereby forming a certain angle therebetween, and the angle is adapted to the requirement of the photovoltaic module 93 for maximizing power generation.

After the front support legs 92 and the rear support legs 91 are connected to the first supporting plates 2, the front support legs 92 are connected to a transverse guide rail 94 by means of bolt sets, and the rear support legs 91 are connected to another transverse guide rail 94 by means of bolt sets. Each of the transverse guide rails 94 is provided with several pressing blocks 96, and an upper rubber strip and a lower rubber strip are provided between the transverse guide rail 94 and the pressing blocks 96. The photovoltaic module 93 is clamped between the upper and lower rubber strips. The photovoltaic module 93 and the transverse guide rails 94, the support legs (the front support legs 92 and the rear support legs 91) and the floating body 1 are reliably connected to form an integral structure by the bolt sets. A tie rod 95 and a connecting pair are provided between the transverse guide rails 94 or between the support legs for position limiting, to prevent the floating body 1 from transmitting the deformation, caused by thermal expansion, to the transverse guide rails 94, the rear support leg 91, the front support leg 92 and the pressing blocks 96, and eliminates the risk of falling off of the connecting assembly caused by insufficient clamping area of the pressing blocks 96.

The photovoltaic module floating supporting structures, floating walkways 99, floating bodies for convergence boxes and string inverters 97, and bolt-nut connecting pairs 32 are connected contiguously. The photovoltaic modules 93 are installed on the photovoltaic module floating supporting structures by means of bracket assemblies, to achieve reliable arrangement of components of a floating square array, and achieve operability and maintainability of all parts of the floating square array.

According to the above description, in the photovoltaic module floating supporting structure according to the present application, since the first supporting plate 2 is integrally formed with the floating body 1, the first supporting plate 2 has a solid structure, and the first supporting plate 2 is provided with the first connection positioning hole 5, thus the stress concentration is avoided, and the strengths of the first supporting plate 2 and the connecting assembly are improved, and even though the first connection positioning hole 5 is broken, it can be repaired, thereby ensuring the safety of power generation of the photovoltaic module, and effectively prolonging the service life of the photovoltaic module floating supporting structure.

Further, the photovoltaic module floating supporting structure further includes a second supporting plate 8 integrally formed with the floating body 1. A second connection positioning hole is provided in the second supporting plate 8 for facilitating mounting the connecting assembly for the worker. The number of the first connection positioning hole 5 and the number of the second connection positioning hole can be determined according to the practical requirements. In order to improve the connection strength, it is preferable that multiple first connection positioning holes 5 and multiple second connection positioning holes are provided. In order to facilitate the formation of the second supporting plate 8 and improve the connection strength, it is preferable that the second supporting plate 8 has a solid structure. In order to improve the overall stability, it is preferable that an inner support groove is formed by the second supporting plate 8 and the upper surface of the floating body 1, and an inclined support, arranged in the inner support groove, of the end of the connecting assembly transmits an action force of the photovoltaic module in a north-south direction into the inner support groove of the floating body 1. Preferably, the upper surface of the first supporting plate 2 is provided with a first drainage groove 6 in communication with the first connection positioning hole 5 and/or an upper surface of the second supporting plate 8 is provided with a second drainage groove in communication with the second connection positioning hole, and accumulated water can be discharged through the first drainage groove 6 and the second drainage groove. The front and rear supports are connected by support connecting pairs in the form of bolts. The floating body 1 has several first supporting plates 2 and several second supporting plates 8. The first supporting plates 2 are configured to transmit the vertical load of the photovoltaic module 93 and the second supporting plates 8 are configured to transmit transverse loads of the photovoltaic module 93 and the connecting assembly, thereby enhancing the stability of the photovoltaic module when suffered from the wind.

The floating body 1, the first supporting plates 2 and the second supporting plates 8 are integrally formed, and the first supporting plates 2, the second supporting plates 8 and the floating body 1 are integrally molded by blow molding to form a solid region.

The upper surface of the floating body 1 is provided with an inclined support groove 7 configured to connect the first supporting plate 2 to the second supporting plate 8. The photovoltaic module floating supporting structure and the photovoltaic module 93 are reliably secured to form an integral structure by the front support legs 92, the rear support legs 91, the transverse guide rails 94, and the pressing blocks 96, and a certain angle of inclination is formed between the photovoltaic module floating supporting structure and the photovoltaic module 93, and the above combined integral structure and floating bodies of other specifications are spliced together by the connecting lugs 3 to form a square array, and to eventually form a floating photovoltaic power generation array. The inclined support groove 7 is configured to assist the force transmission between the floating body 1 and the front support of the connecting assembly as well as between the floating body 1 and the inclined support of the connecting assembly, to enhance the transverse resistance of the photovoltaic assembly when subjected from the wind, to improve the stability of the photovoltaic assembly in the north-south direction, and to improve the wind resistance. By providing the second supporting plate 8 and the inclined support of the connecting assembly, the possibility that the positioning portion of the floating body is subjected to a stress for a long time and has a creep deformation accordingly is reduced.

Preferably, the upper surface of the floating body 1 is provided with an upper reinforcing rib 19, and the number of the reinforcing rib 19 is determined according to the practical requirements. Preferably, the reinforcing rib 19 extends along a length direction of the floating body 1, and in the case that multiple reinforcing ribs 19 are provided, the multiple reinforcing ribs 19 are arranged sequentially at equal intervals. By providing the reinforcing ribs 19, the photovoltaic module floating supporting structures can be stressed uniformly when being stacked for transportation, to prevent the situation that the photovoltaic module floating supporting structure is deformed by non-uniform force and damaged accordingly when the photovoltaic module floating supporting structures are stacked too high in transportation.

On the basis of the above solutions, as shown in FIG. 9 and FIG. 15, it is preferable that the floating body 1 is provided with a cooling hole 4, and two ends of the cooling hole 4 are respectively in communication with the upper surface of the floating body 1 and the lower surface of the floating body 1, that is, the floating body 1 has a ventilation cooling hole configured to communicate the photovoltaic module 93 with the water surface. The floating supporting structure for the photovoltaic module 93 is formed by hollow blow molding a resin material through an air blowing port 11, and the floating body 1 has a cooling hole 4 in the middle, and the cooling hole 4 functions to connect the water surface and the photovoltaic module 93 to allow heat transfer, to reduce the operating temperature of the photovoltaic module 93, and reduce the reaction force of the water surface wave to the floating body 1.

As shown in FIG. 6, the upper surface of the floating body 1 is provided with a first drainage passage 110 and a second drainage passage 111. The first drainage passage 110 is concaved inward from two ends of the floating body 1 toward the center of the floating body 1. Two of the second drainage passages 111 are respectively arranged at two opposite sides of the bottommost portion of the first drainage passage 110. Each of the second drainage passages 111 has one end in communication with the first drainage passage 110 and another end extending to the outer periphery of the floating body 1 to form a drainage opening. When rainwater falls onto the upper surface of the floating body 1, the rainwater flows through the first drainage passage 110 to the second drainage passages 111, and then is discharged through the second drainage passages 111, thereby avoiding the rainwater from being accumulated on the floating body 1, and effectively prolonging the service life of the photovoltaic module floating supporting structure.

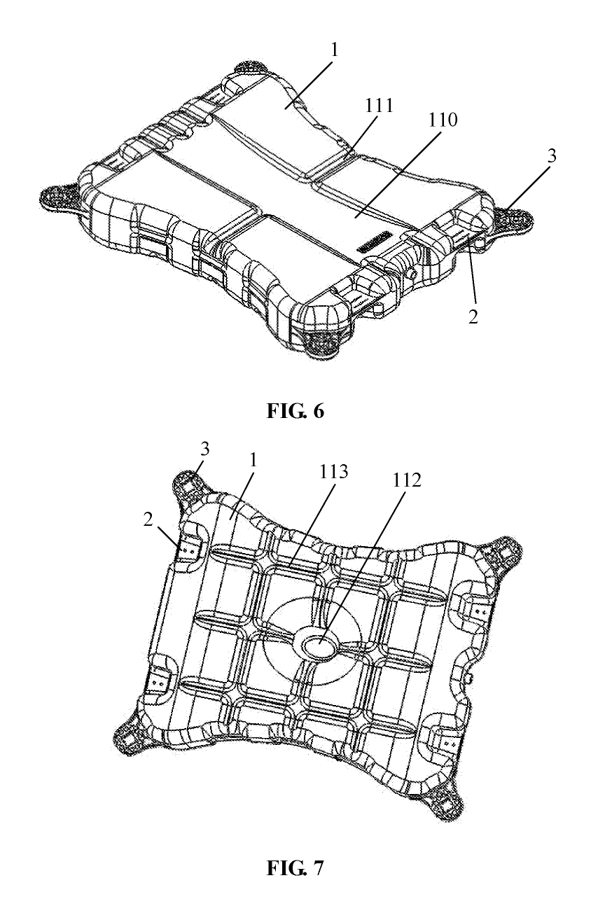

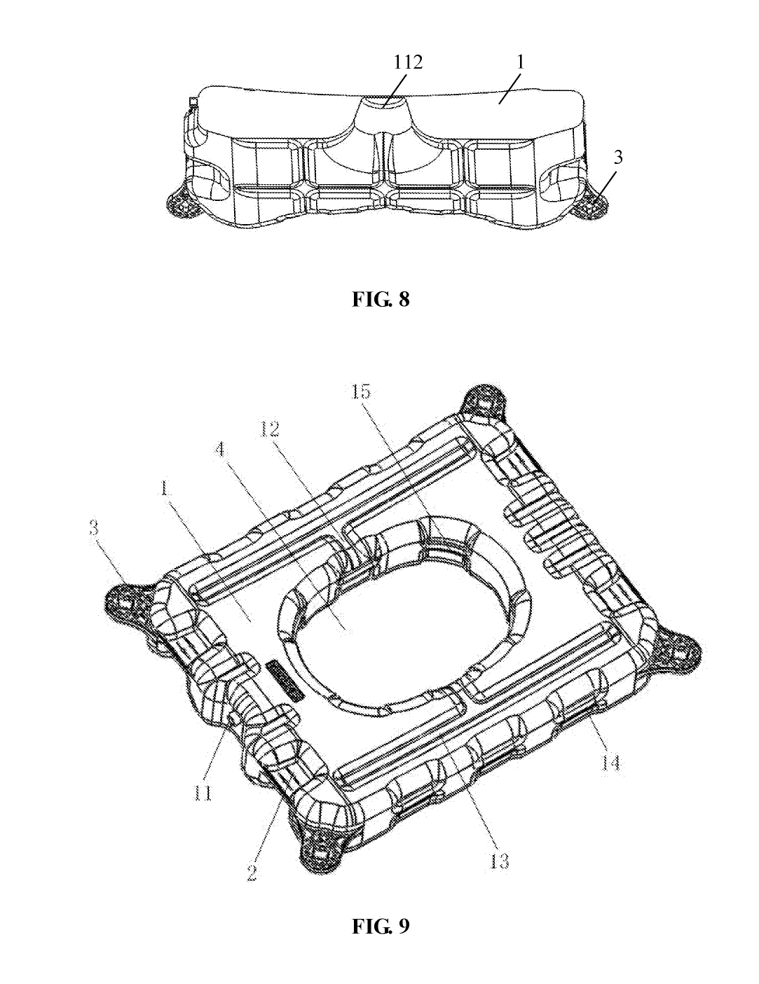

As shown in FIG. 7 and FIG. 8, the lower surface of the floating body 1 is provided with a reinforcement supporting member 112, and the reinforcement supporting member 112 is integrally formed with the floating body 1. The reinforcement supporting member 112 has two ends respectively connected to the upper surface and the lower surface of the floating body 1. Specifically, the reinforcement supporting member 112 is in smooth transition with the upper surface and the lower surface of the floating body 1. Preferably, the reinforcement supporting member 112 has a solid structure, and its cross-sectional area increases gradually from top to down. By arranging the reinforcement supporting member 112 in the floating body 1, the service life of the photovoltaic module floating supporting structure is further prolonged.

Preferably, the reinforcement supporting member 112 is located at the center of the floating body 1, the lower surface of the floating body 1 is provided with a bottom supporting strip 113 surrounding the reinforcement supporting member 112, and the bottom supporting strip 113 is integrally formed with the floating body 1. Preferably, the lower surface of the floating body 1 is concaved inward from the outer periphery toward the center, and the bottom end of the reinforcement supporting member 112 flushes with the lower surface of the floating body 1. Preferably, the bottom supporting strip 113 includes a transverse supporting strip and a longitudinal supporting strip crossing each other at right angles. Specifically, the number of the transverse supporting strip and the longitudinal supporting strip can be determined according to the actual requirements, which will not be limited herein. By providing the bottom supporting strip 113, the overall intensity of the photovoltaic module floating supporting structure is further increased, which further prolongs the service life of the photovoltaic module floating supporting structure.

Certainly, multiple reinforcement supporting members 112 may be provided. Preferably, the multiple reinforcement supporting members 112 are arranged in matrix.

Further, a side surface, for forming the cooling hole 4, of the floating body 1 is provided with an inner sidewall reinforcing rib 15. Preferably, the inner sidewall reinforcing rib 15 is arranged transversely, multiple inner sidewall reinforcing ribs 15 are provided, and the multiple inner sidewall reinforcing ribs 15 are distributed at equal intervals in a peripheral direction of the cooling hole 4. Preferably, the inner sidewall reinforcing rib 15 is arranged horizontally, and the service life of the floating body 1 is effectively prolonged by providing the inner sidewall reinforcing ribs 15.

Further, as shown in FIG. 1 to FIG. 5, the upper surface of the floating body 1 is provided with a transverse reinforcing rib 12 and a longitudinal reinforcing rib 13 arranged perpendicular to the transverse reinforcing rib 12. The transverse reinforcing rib 12 is connected to the longitudinal reinforcing rib 13, and a side surface of the floating body 1 is provided with an outer sidewall reinforcing rib 14. Preferably, the lower surface of the floating body 1 is provided with a bottom reinforcing rib 18. The floating body 1 has several outer sidewall reinforcing ribs 14, several transverse reinforcing ribs 12, several longitudinal reinforcing ribs 13 and several bottom reinforcing ribs 18 which are all recessed inwardly from the surface of the floating body, to improve the anti-deformation capability of the surface of the floating body 1 and increase the bending resistant section modulus of the floating body 1 in the vertical direction.

The connecting lug 3 has several anti-reverse rotating holes 32, each of the anti-reverse rotating holes 32 has a step-shaped side wall, to prevent the free rotation of the bolt set and achieve the purpose of preventing loosening of the connection structure. Preferably, the anti-reverse rotating holes 32 are distributed along a peripheral direction of the connecting lug positioning hole 31 of the connecting lug 3.

As shown in FIG. 15, the first supporting plate 2 and the connecting lug 3 are integrally formed, and the mounting surface of the connecting lug 3 is coplanar with the mounting surface of the first supporting plate 2, thereby facilitating the formation of the photovoltaic module floating supporting structure.

The floating body 1 has an approximate rectangular structure as a whole, and the floating body has a simple configuration, is easy to manufacture and easy to control the quality. The components of the floating body 1 are simple and can be mounted fast.

On the basis of the above solutions, it is preferable that the upper surface of the floating body 1 includes an arc-shaped reinforcing surface 16 recessed toward the center of the upper surface of the floating body 1 and a flat surface 17 surrounding the periphery of the arc-shaped reinforcing surface 16, and the flat surface 17 is smoothly connected to a side portion of the arc-shaped reinforcing surface 16. The upper surface of the floating body 1 has the arc-shaped reinforcing surface 16, which improves the bending resistance of the upper surface of the floating body 1 which eliminates the swelling of the upper surface of the floating body 1 caused by the temperature rise, and the swelling may cause deviation of the positioning dimension. The provision of the flat surface 17 facilitates the transportation of the photovoltaic module floating supporting structures in the stacked state, and the bottom of an upper photovoltaic module floating supporting structure corresponds to the flat surface 17 of a lower photovoltaic module floating supporting structure, to prevent an irreversible deformation of the photovoltaic module floating supporting structure in the process of transportation, thereby improving the stability of the transportation and facilitating the transportation of the photovoltaic module floating supporting structures which are bound together.

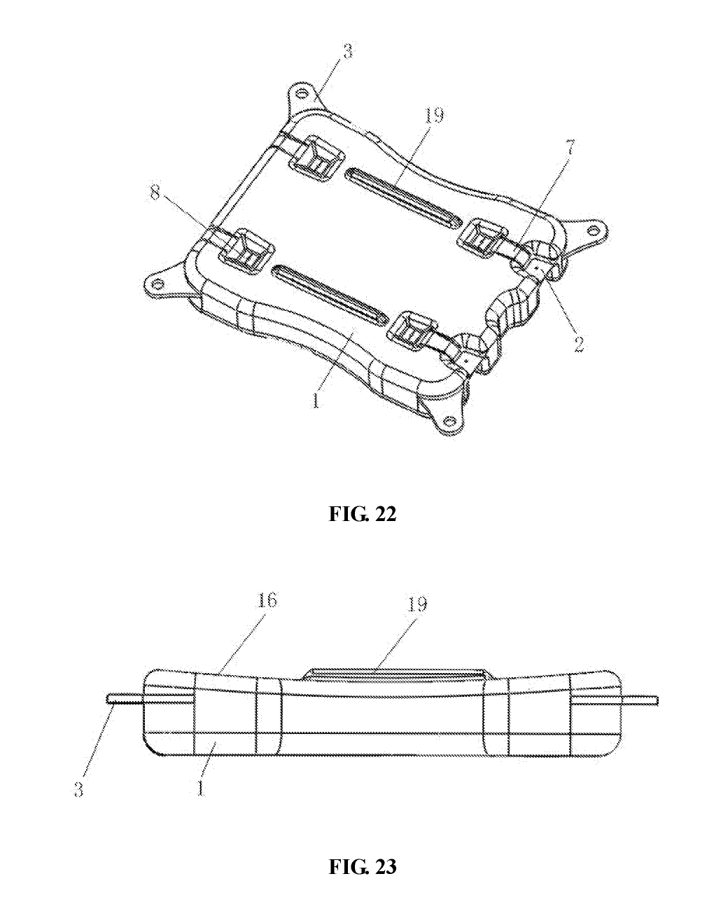

As shown in FIG. 22 to FIG. 29 the floating body includes several connecting lugs 3 and several first supporting plates 2, and each of the first supporting plates 2 is provided with a connecting pair connected to the connecting assembly, and the connecting pair is connected to a corresponding connecting lug 3 and passes through the connecting lug 3. Front inclined supports and rear inclined supports of the connecting assembly are connected to the first connection positioning holes 5 respectively by bolt sets and are reliably fixed. The front and rear inclined supports are connected to the photovoltaic module 93 at a certain angle and are directly connected to predetermined press-fit positions of the photovoltaic module 93, thus it is not necessary to additionally provide the pressing blocks 96 and the transverse guide rails 94. After being connected to the front inclined supports and the rear inclined supports, the photovoltaic module 93 is located above the floating body 1 and a certain inclination angle is formed between the photovoltaic module 93 and the floating body 1. After the floating body 1 is connected to the photovoltaic module 93, the floating body 1 is connected to floating bodies of other specifications by the connecting lugs 3, to form a floating photovoltaic array. Since the bottom of the floating body 1 is provided with the first connection positioning hole 5 for facilitating the installation, it is convenient to use the tool for installing the bolts; and since the transverse guide rails 94 are not required, and the cost of the bracket is reduced and the dimension of the floating body 1 is reduced, the cost of the photovoltaic module floating supporting structure is reduced.

The above embodiments are described in a progressive manner. Each of the embodiments is mainly focused on describing its differences from other embodiments, and references may be made among these embodiments with respect to the same or similar portions among these embodiments.

Based on the above description of the disclosed embodiments, the person skilled in the art is capable of carrying out or using the present application. It is obvious for the person skilled in the art to make many modifications to these embodiments. The general principle defined herein may be applied to other embodiments without departing from the spirit or scope of the present application. Therefore, the present application is not limited to these embodiments illustrated herein, but should be defined by the broadest scope consistent with the principle and novel features disclosed herein.

What is claimed is:

1. A photovoltaic module floating supporting structure, comprising a floating body, and further comprising a first supporting plate integrally formed with the floating body and configured to be connected to a connecting assembly, wherein the first supporting plate has an upper surface smoothly connected to an upper surface of the floating body and a lower surface smoothly connected to a lower surface of the floating body.

2. The photovoltaic module floating supporting structure according to claim 1, further comprising a second supporting plate integrally formed with the floating body and configured to be connected to the connecting assembly, wherein an inner support groove is defined by the second supporting plate and the upper surface of the floating body.

3. The photovoltaic module floating supporting structure according to claim 2, wherein the first supporting plate and/or the second supporting plate are solid structures.

4. The photovoltaic module floating supporting structure according to claim 2, wherein the upper surface of the first supporting plate is provided with a first connection positioning hole and a first drainage groove in communication with the first connection positioning hole;
and/or, an upper surface of the second supporting plate is provided with a second connection positioning hole and a second drainage groove in communication with the second connection positioning hole.

5. The photovoltaic module floating supporting structure according to claim 2, wherein the first supporting plate is arranged on a lateral side of the floating body, a plurality of first supporting plates are provided, and the plurality of first supporting plates are symmetrically distributed at opposite sides of the floating body along a center line of the floating body.

6. The photovoltaic module floating supporting structure according to claim 2, wherein the upper surface of the floating body is provided with an inclined support groove configured to connect the first supporting plate to the second supporting plate.

7. The photovoltaic module floating supporting structure according to claim 1, wherein the floating body is provided with a cooling hole, and two ends of the cooling hole are respectively in communication with the upper surface of the floating body and the lower surface of the floating body.

8. The photovoltaic module floating supporting structure according to claim 7, wherein a side surface, for forming the cooling hole, of the floating body is provided with an inner sidewall reinforcing rib, a plurality of inner sidewall reinforcing ribs are provided, and the plurality of inner sidewall reinforcing ribs are distributed at equal intervals in a peripheral direction of the cooling hole.

9. The photovoltaic module floating supporting structure according to claim 1, wherein the upper surface of the floating body is provided with a transverse reinforcing rib and a longitudinal reinforcing rib arranged perpendicularly to the transverse reinforcing rib, the transverse reinforcing rib is connected to the longitudinal reinforcing rib, a lateral side of the floating body is provided with an outer sidewall reinforcing rib, and the lower surface of the floating body is provided with a bottom reinforcing rib.

10. The photovoltaic module floating supporting structure according to claim 9, wherein each of the transverse reinforcing rib, the longitudinal reinforcing rib and the bottom reinforcing rib is recessed inwardly from the respective surface of the floating body.

11. The photovoltaic module floating supporting structure according to claim 1, wherein the upper surface of the floating body comprises an arc-shaped reinforcing surface recessed toward a center of the upper surface of the floating body and a flat surface surrounding a periphery of the arc-shaped reinforcing surface, and the flat surface is smoothly connected to a side portion of the arc-shaped reinforcing surface.

12. The photovoltaic module floating supporting structure according to claim 1, further comprising a connecting lug, wherein the first supporting plate and the connecting lug are integrally formed, and a mounting surface of the connecting lug is coplanar with a mounting surface of the first supporting plate.

13. The photovoltaic module floating supporting structure according to claim 1, wherein, the upper surface of the floating body is provided with a first drainage passage concaved inward from two ends of the floating body toward a center of the floating body and two second drainage passages respectively arranged at two opposite sides of a bottommost portion of the first drainage passage, and each of the second drainage passages has one end in communication with the first drainage passage and another end extending to an outer periphery of the floating body to form a drainage opening.

14. The photovoltaic module floating supporting structure according to claim 1, wherein, the lower surface of the floating body is provided with a reinforcement supporting member, the reinforcement supporting member is integrally formed with the floating body, and the reinforcement supporting member has two ends respectively connected to the upper surface and the lower surface of the floating body.

15. The photovoltaic module floating supporting structure according to claim 14, wherein, the reinforcement supporting member is located at a center of the floating body, the lower surface of the floating body is provided with a bottom supporting strip surrounding the reinforcement supporting member, and the bottom supporting strip is integrally formed with the floating body.
